(19) United States
(12) Patent Application Publication
(10) Pub. No.: US 2026/0259749 A1
(43) Pub. Date: Sep. 3, 2026

(54) INFORMATION PROCESSING APPARATUS, INTERACTIVE SYSTEM, INTERACTION CONTROL METHOD, AND NON-TRANSITORY RECORDING MEDIUM

(71) Applicants: Mika ONUKI, Kanagawa (JP); Chihiro ASADA, Nara (JP); Masaki NOSE, Kanagawa (JP)

(72) Inventors: Mika ONUKI, Kanagawa (JP); Chihiro ASADA, Nara (JP); Masaki NOSE, Kanagawa (JP)

(21) Appl. No.: 19/539,094

(22) Filed: Feb. 13, 2026

(30) Foreign Application Priority Data
Feb. 28, 2025 (JP) 2025-030951
Oct. 29, 2025 (JP) 2025-182758

(51) Int. Cl. G06F 9/451; G06F 3/16

(52) U.S. Cl. CPC G06F 9/451; G06F 3/167

(57) ABSTRACT

An information processing apparatus includes circuitry that receives an input from a user, evaluates a willingness of the user to continue an interaction, based on the input, and outputs a response related to ending the interaction, based on a result of the evaluation.

### CROSS-REFERENCE TO RELATED APPLICATIONS

This patent application is based on and claims priority pursuant to 35 U.S.C. §119(a) to Japanese Patent Application Nos. 2025-030951, filed on February 28, 2025, and 2025-182758, filed on October 29, 2025, in the Japan Patent Office, the entire disclosure of which is hereby incorporated by reference herein.

### BACKGROUND

### Technical Field

The present disclosure relates to an information processing apparatus, an interactive system, an interaction control method, and a non-transitory recording medium.

### Related Art

There is an interactive system that automatically responds to a user's utterance. There is also an information providing system that estimates a user's participation attitude from content of the user's utterances and creates a conversation comment that interests the user based on the estimated user's participation attitude.

### SUMMARY

The present disclosure described herein provides an information processing apparatus including circuitry that receives an input from a user, evaluates a willingness of the user to continue an interaction, based on the input, and outputs a response related to ending the interaction, based on a result of the evaluation.

The present disclosure described herein provides an interactive system including the information processing apparatus described above, and a terminal apparatus to communicate with the information processing apparatus via a communication network and to be used by the user. The terminal apparatus includes another circuitry that transmits the input from the user to the information processing apparatus, receives the response from the information processing apparatus, and controls outputting of the response to the user.

The present disclosure described herein provides an interaction control method including receiving an input from a user; evaluating a willingness of the user to continue an interaction, based on the input; and controlling a response related to ending the interaction to the user, based on a result of the evaluating.

The present disclosure described herein provides a non-transitory recording medium storing a plurality of instructions which, when executed by one or more processors, causes the one or more processors to perform an interaction control method including receiving an input from a user; evaluating a willingness of the user to continue an interaction, based on the input; and controlling a response related to ending the interaction to the user, based on a result of the evaluating.

### BRIEF DESCRIPTION OF THE DRAWINGS

A more complete appreciation of embodiments of the present disclosure and many of the attendant advantages and features thereof can be readily obtained and understood from the following detailed description with reference to the accompanying drawings, wherein:

FIG. 1 is a diagram illustrating an example of a configuration of an interactive system;

FIG. 2 is a diagram illustrating an example of a hardware configuration of a computer;

FIG. 3 is a diagram illustrating an example of a hardware configuration of a terminal apparatus;

FIG. 4 is a diagram illustrating an example of a functional configuration of the interactive system;

FIG. 5 is a diagram for describing user information;

FIG. 6 is a sequence diagram illustrating an example of a process of an interactive system according to a first embodiment;

FIG. 7 is a flowchart illustrating an example of an interaction process according to the first embodiment;

FIGS. 8A and 8B (FIG. 8) are a diagram illustrating an example of an interaction history according to the first embodiment;

FIG. 9 is a sequence diagram illustrating an example of a process of an interactive system according to a second embodiment;

FIG. 10 is a sequence diagram illustrating an example of an interaction initiation process according to a third embodiment;

FIG. 11 is a diagram illustrating an example of a prompt according to the third embodiment;

FIG. 12 is a diagram illustrating an example of an interaction initiation screen according to the third embodiment;

FIG. 13 is a diagram for describing a process performed when an image is acquired according to the third embodiment;

FIG. 14 is a diagram illustrating an example of a prompt according to the third embodiment;

FIG. 15 is a flowchart illustrating an example of an evaluation process according to a fourth embodiment;

FIG. 16 is a diagram for describing evaluation based on an uttered word count according to the fourth embodiment; and

FIG. 17 is a flowchart illustrating an example of an evaluation process according to a fifth embodiment.

The accompanying drawings are intended to depict embodiments of the present disclosure and should not be interpreted to limit the scope thereof. The accompanying drawings are not to be considered as drawn to scale unless explicitly noted. Also, identical or similar reference numerals designate identical or similar components throughout the several views.

### DETAILED DESCRIPTION

In describing embodiments illustrated in the drawings, specific terminology is employed for the sake of clarity. However, the disclosure of this specification is not intended to be limited to the specific terminology so selected and it is to be understood that each specific element includes all technical equivalents that have a similar function, operate in a similar manner, and achieve a similar result.

Referring now to the drawings, embodiments of the present disclosure are described below. As used herein, the singular forms "a," "an," and "the" are intended to include the plural forms as well, unless the context clearly indicates otherwise.

### Overview

There is an interactive system that automatically responds to a user's utterance. For such an interactive system, there is a technique in which a large language model (LLM) is provided with content of a user's utterance together with an instruction to generate a response, and returns a linguistically natural response.

The interactive system to date, however, fails to sense that the user is bored of the interaction and continues the interaction. This leads to a decrease in user satisfaction.

An assumed use of an interactive system according to embodiments of the present disclosure is for reminiscence therapy at care facilities. In reminiscence therapy, it is recognized that presenting photographs familiar to a user is highly effective. Presenting such photographs during an interaction can appeal to the user's vision and draw the user's attention. The use of photographs is also effective when a topic is presented and is expected to be a tool for deepening the user's understanding and interest.

However, the technique of the related art fails to output a response for ending an interaction based on the user's utterances while taking into account the progress of the interaction, for example, the fact that the user's likelihood of becoming bored increases as the duration of the interaction for a topic increases.

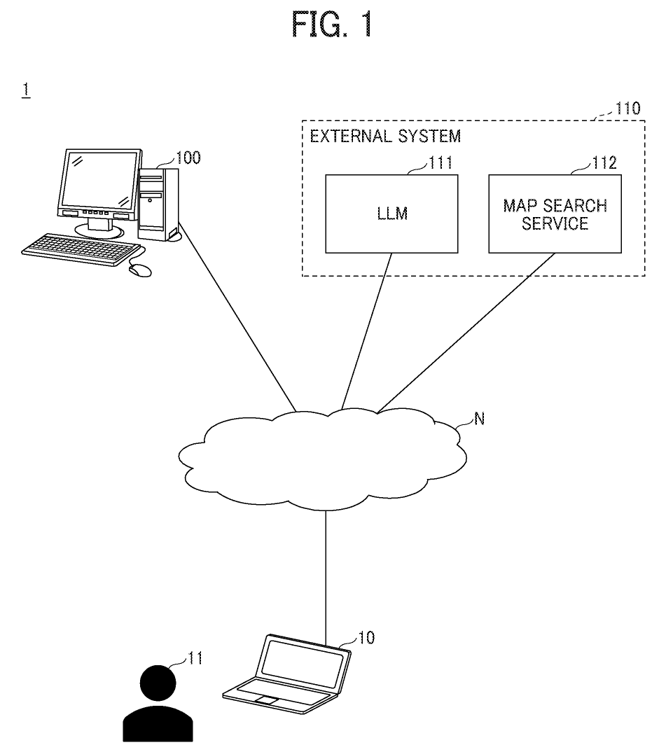

Accordingly, an interactive system according to embodiments of the present disclosure automatically responds to a user's utterance and has a configuration illustrated in FIGS. 1 to 4 to successfully control ending of an interaction by taking into account the progress of the interaction.

### System Configuration

FIG. 1 is a diagram illustrating an example of a system configuration of an interactive system according to an embodiment. An interactive system 1 includes a server apparatus 100 and a terminal apparatus 10 that are connected to each other via a communication network N such as Internet and a local area network (LAN), for example.

The server apparatus (information processing apparatus) 100 is, for example, an information processing apparatus having a configuration of a computer or a system including multiple computers, and communicates with the terminal apparatus 10 and an external system 110 via the communication network N. A computer of the server apparatus 100 executes a predetermined program, so that the server apparatus 100 provides an interaction service for automatically responding to an utterance of a user 11 who uses the terminal apparatus 10.

The server apparatus 100 is an example of an information processing apparatus according to embodiments of the present disclosure.

The external system 110 includes an LLM 111 and a map search service 112 provided from outside of the interactive system 1. The LLM 111 and the map search service 112 may be provided by the same provider or by different providers. The LLM 111 is a large language model built based on a large amount of text data and deep learning technology. The LLM 111 has an ability to perform various natural language processing tasks such as reading, understanding, generation, translation, and summarizing text and responding to text, for example. In embodiments of the present disclosure, for example, an existing LLM such as ChatGPT is used as the LLM 111 without any modification.

The map search service 112 is a service for searching for map information, facility information, and route information via the communication network N, for example. In embodiments of the present disclosure, for example, an existing map search service such as Google Maps^{®} is used as the map search service 112 without any modification.

The terminal apparatus 10 is, for example, an information terminal such as a personal computer (PC), a tablet terminal, or a smartphone, which is used by the user 11. The terminal apparatus 10 communicates with the server apparatus 100 via the communication network N. The user 11 uses the terminal apparatus 10 to use the interaction service provided by the server apparatus 100.

### Hardware Configuration

### Hardware Configuration of Computer

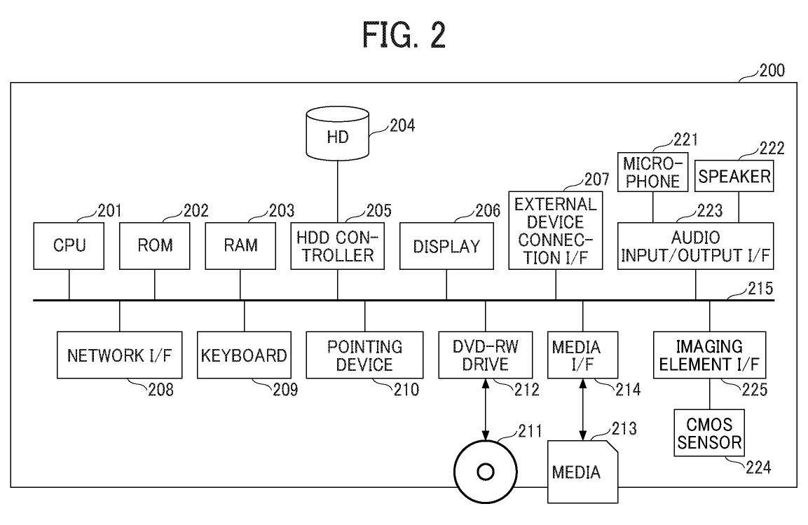

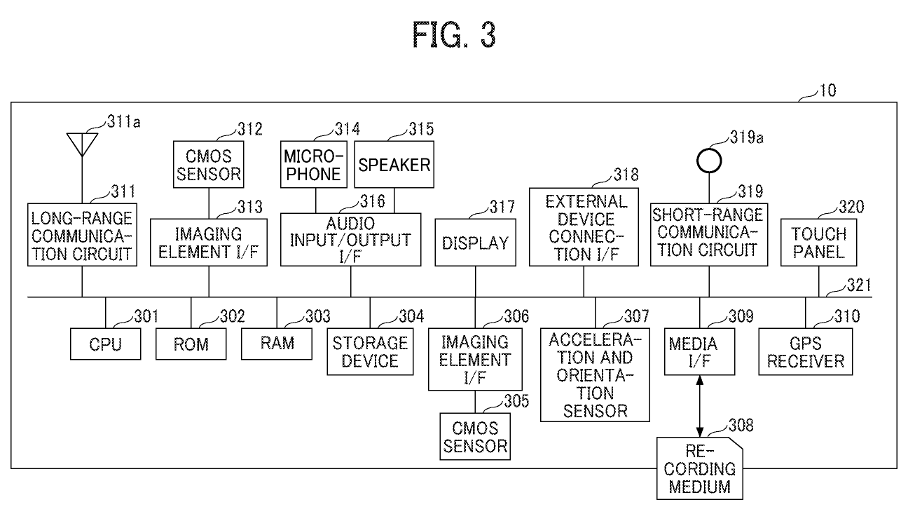

For example, the server apparatus 100 has a hardware configuration of a computer 200 illustrated in FIG. 2. In another embodiment, the server apparatus 100 includes multiple computers 200. For example, the terminal apparatus 10 has a hardware configuration of the terminal apparatus 10 described later with reference to FIG. 3 or a hardware configuration of the computer 200 illustrated in FIG. 2.

FIG. 2 is a diagram illustrating an example of a hardware configuration of the computer according to an embodiment. As illustrated in FIG. 2, the computer 200 includes, for example, a central processing unit (CPU) 201, a read-only memory (ROM) 202, a random access memory (RAM) 203, a hard disk (HD) 204, a hard disk drive (HDD) controller 205, a display 206, an external device connection interface (I/F) 207, a network I/F 208, a keyboard 209, a pointing device 210, a digital versatile disk rewritable (DVD-RW) drive 212, a media I/F 214, and a bus line 215. The computer 200 may further include another processor such as a graphics processing unit (GPU), for example.

In a case where the computer 200 operates as the terminal apparatus 10, the computer 200 further includes, for example, a microphone 221, a speaker 222, an audio input/output I/F 223, a complementary metal oxide semiconductor (CMOS) sensor 224, and an imaging element I/F 225.

The CPU 201 controls the overall operation of the computer 200. The ROM 202 stores a program such as an initial program loader (IPL) used for booting the computer 200, for example. The RAM 203 is used as a work area for the CPU 201, for example. The HD 204 stores programs such as an operating system (OS), applications, and device drivers and various types of data, for example. The HDD controller 205 controls reading and writing of various types of data from and to the HD 204 under control of the CPU 201, for example. The HD 204 and the HDD controller 205 are an example of a storage device.

The display 206 displays various types of information such as a cursor, a menu, a window, characters, and an image, for example. The display 206 may be external to the computer 200. The external device connection I/F 207 is an interface for connecting various external devices to the computer 200. The network I/F 208 is an interface for connecting the computer 200 to the communication network N to communicate with other apparatuses.

The keyboard 209 is an example of an input device provided with multiple keys used for inputting characters, numerical values, and various instructions. The pointing device 210 is an example of an input device that allows selection or execution of various instructions, selection of a processing target, and movement of a cursor, for example. The keyboard 209 and the pointing device 210 may be external to the computer 200.

The DVD-RW drive 212 controls reading and writing of various types of data from and to a DVD-RW 211, which is an example of a removable recording medium. The removable recording medium is not limited to the DVD-RW 211 and may be any other removable recording medium. The media I/F 214 controls reading and writing (storing) of data from and to media 213 such as a flash memory. The bus line 215 includes an address bus, a data bus, various control signal lines, and the like for electrically connecting the components described above to one another.

The microphone 221 is a built-in circuit that converts sound into an electrical signal. The speaker 222 is a built-in circuit that converts an electrical signal into physical vibration to produce sound such as music or voice. The audio input/output I/F 223 is a circuit that processes the input and output of audio signals between the microphone 221 and the speaker 222 under control of the CPU 201.

The CMOS sensor 224 is an example of a built-in imaging device that captures an image of a subject (e.g., an image of a user) under control of the CPU 201 to obtain image data. The computer 200 may include any desired imaging device such as a charge coupled device (CCD) sensor instead of the CMOS sensor 224. The imaging element I/F 225 is a circuit that controls driving of the CMOS sensor 224.

### Example of Hardware Configuration of Terminal Apparatus

FIG. 3 is a diagram illustrating an example of a hardware configuration of the terminal apparatus according to an embodiment. An example of the hardware configuration of the terminal apparatus 10 in a case where the terminal apparatus 10 is an information terminal such as a smartphone or a tablet terminal will be described.

In the example illustrated in FIG. 3, the terminal apparatus 10 includes a CPU 301, a ROM 302, a RAM 303, a storage device 304, a CMOS sensor 305, an imaging element I/F 306, an acceleration and orientation sensor 307, a media I/F 309, and a Global Positioning System (GPS) receiver 310.

The CPU 301 executes a predetermined program to control the overall operation of the terminal apparatus 10. The ROM 302 stores a program such as an IPL used to boot the CPU 301, for example. The RAM 303 is used as a work area for the CPU 301. The storage device 304 is a large-capacity storage device that stores programs such as an OS and applications and various types of data. The storage device 304 is implemented by, for example, a solid state drive (SSD) or a flash ROM.

The CMOS sensor 305 is an example of a built-in imaging device that captures an image of a subject (e.g., an image of the user) under control of the CPU 301 to obtain image data. The terminal apparatus 10 may include any desired imaging device such as a CCD sensor instead of the CMOS sensor 305. The imaging element I/F 306 is a circuit that controls driving of the CMOS sensor 305. The acceleration and orientation sensor 307 includes various sensors such as an electromagnetic compass that detects geomagnetism or a gyrocompass, and an acceleration sensor. The media I/F 309 controls reading and writing (storing) of data from and to media (storage media) 308 such as a flash memory. The GPS receiver 310 receives a GPS signal (positioning signal) from a GPS satellite.

The terminal apparatus 10 further includes a long-range communication circuit 311, an antenna 311a for the long-range communication circuit 311, a CMOS sensor 312, an imaging element I/F 313, a microphone 314, a speaker 315, an audio input/output I/F 316, a display 317, an external device connection I/F 318, a short-range communication circuit 319, an antenna 319a for the short-range communication circuit 319, and a touch panel 320.

The long-range communication circuit 311 is a circuit that communicates with other apparatuses via the communication network N, for example. The CMOS sensor 312 is an example of a built-in imaging device that captures an image of a subject under control of the CPU 301 to obtain image data. The imaging element I/F 313 is a circuit that controls driving of the CMOS sensor 312. The microphone 314 is a built-in circuit that converts sound into an electrical signal. The speaker 315 is a built-in circuit that converts an electrical signal into physical vibration to produce sound such as music or voice. The audio input/output I/F 316 is a circuit that processes the input and output of audio signals between the microphone 314 and the speaker 315 under control of the CPU 301.

The display 317 is an example of a display such as a liquid crystal display (LCD) or an organic electroluminescent (EL) display that displays, for example, an image of a subject or various icons. The external device connection I/F 318 is an interface for connecting various external devices to the terminal apparatus 10. The short-range communication circuit 319 includes a circuit for performing short-range wireless communication. The touch panel 320 is an example of an input device that allows a user to operate the terminal apparatus 10 by touching the display 317.

The terminal apparatus 10 further includes a bus line 321. The bus line 321 includes, for example, an address bus or a data bus that electrically connects the components such as the CPU 301 illustrated in FIG. 3.

The hardware configuration of the terminal apparatus 10 illustrated in FIG. 3 is an example. The terminal apparatus 10 may have any other hardware configuration that includes, for example, the configuration of a computer, a communication circuit, a display, a microphone, and a speaker.

### Functional Configuration

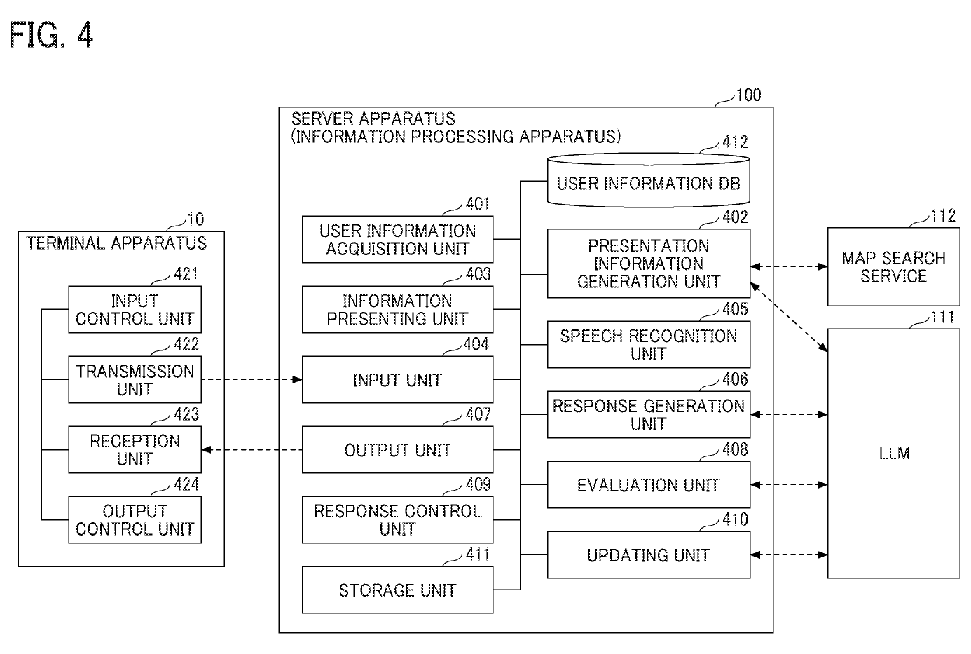

FIG. 4 is a diagram illustrating an example of a functional configuration of the interactive system according to an embodiment of the present disclosure.

### Functional Configuration of Server Apparatus

The CPU 201 of the server apparatus 100 executes a predetermined program stored on a storage medium, so that the server apparatus 100 implements functional components illustrated in FIG. 4, for example. In the example illustrated in FIG. 4, the server apparatus 100 includes functional components such as a user information acquisition unit 401, a presentation information generation unit 402, an information presenting unit 403, an input unit 404, a speech recognition unit 405, a response generation unit 406, an output unit 407, an evaluation unit 408, a response control unit 409, an updating unit 410, a storage unit 411, and a user information database (DB) 412. At least one of the functional components mentioned above may be implemented by hardware.

The user information acquisition unit 401 performs a user information acquisition process for acquiring user information from the user information DB 412. The user information is information on a user who uses the terminal apparatus 10.

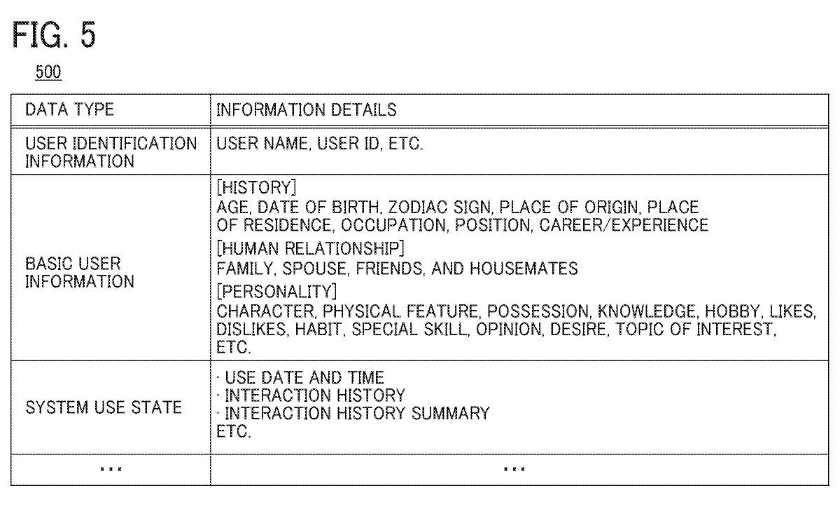

FIG. 5 is a diagram for describing the user information according to an embodiment. User information 500 includes data types such as user identification information, basic user information, and a system use state, for example. The user identification information is information for identifying a user, and for example, includes information such as a user name and a user ID.

The basic user information is basic information on a user. The basic user information is used to estimate the topic likely to interest the user. The basic user information includes, for example, information such as a history, a human relationship, and a personality. The history includes one or more pieces of information among pieces of information on the user's age, date of birth, zodiac sign, place of origin, place of residence, occupation, position, career, and experience, for example. The human relationship includes one or more pieces of information among pieces of information on the user's family, spouse, friends, and housemates, for example. The personality includes one or more pieces of information among pieces of information on the user's character, physical feature, possession, knowledge, hobby, likes, dislikes, habit, special skill, opinion, desire, and topic of interest, for example.

The system use state is information related to the user's use history of the interactive system 1. The system use state includes, for example, a use date and time, an interaction history, and an interaction history summary. The use date and time is information indicating the date and time when the user used the interactive system 1. The interaction history is a history of interactions between the user and the interactive system 1. The interaction history summary is a summary of the interaction history obtained using the LLM 111.

In the present embodiment, the user information 500 of each user who uses the interactive system 1 is registered in the user information DB 412 in advance. Preferably, the server apparatus 100 updates the user information 500 based on content of an interaction in a case where the interaction with the user ends.

An assumed use of the interactive system 1 according to embodiments of the present disclosure is use at care facilities.

The presentation information generation unit 402 performs a presentation information generation process for generating information related to a topic that interests the user (e.g., a topic related to the user information) based on the user information acquired by the user information acquisition unit 401. For example, the presentation information generation unit 402 inputs the user information to the LLM 111 to cause the LLM 111 to generate content of utterances that are related to a topic likely to interest the user and that are to be presented to the user to initiate an interaction. Preferably, the presentation information generation unit 402 acquires an image related to the topic likely to interest the user from the map search service 112 or the LLM 111, and generates presentation information including the content of utterances and the image that are related to the topic likely to interest the user.

In a specific example, the presentation information generation unit 402 searches an area of the user's place of origin for a facility likely to interest the user, based on information on the user's place of origin and curiosity and interest, and generates presentation information including an image of the facility and content of utterances related to the facility.

The information presenting unit 403 performs an information presenting process for presenting, to the user, the presentation information related to the topic likely to interest the user and generated by the presentation information generation unit 402 in a case where an interaction with the user starts. For example, the information presenting unit 403 transmits the presentation information, which is generated by the presentation information generation unit 402 and includes the image of the facility likely to interest the user and the content of the utterance related to the facility, to the terminal apparatus 10 to cause the terminal apparatus 10 to display the presentation information.

The input unit 404 performs an input process for receiving an input from the user. For example, the input unit 404 receives, for example, uttered voice of the user, a video of the user including uttered voice of the user, or utterance text of utterances of the user transmitted by the terminal apparatus 10.

The speech recognition unit 405 performs a speech recognition process for applying speech recognition on the uttered voice of the user to acquire utterance text that is text of the uttered voice of the user. For example, when the input unit 404 receives the uttered voice of the user or the video of the user, the speech recognition unit 405 performs the speech recognition process on the received uttered voice of the user or the uttered voice of the user included in the received video of the user.

The response generation unit 406 performs a response generation process for generating a response to the utterance text (hereinafter, simply referred to as a "user's utterance") that is text of the user's utterance. The response generation unit 406 uses the LLM 111 to generate a response to the utterance text. For example, the response generation unit 406 inputs the user's utterance to the existing LLM 111 such as ChatGPT, instructs the LLM 111 to generate a response to the user's utterance, and acquires the response generated by the LLM 111.

The output unit 407 performs an output process for outputting a response in response to a user's input to the input unit 404. For example, the output unit 407 transmits the response generated by the response generation unit 406, as a response to the user's utterance to the terminal apparatus 10.

The output unit 407 may use existing speech synthesis technology to convert the response (i.e., text data) generated by the response generation unit 406, as a response to the user's utterance into speech, and transmit the speech response to the terminal apparatus 10. When the terminal apparatus 10 displays an interactive agent that interacts with the user, the output unit 407 may draw an image of the interactive agent and transmit the drawn image of the interactive agent to the terminal apparatus 10. The terminal apparatus 10 may perform the processing for converting utterance text into speech and for drawing an image of the interactive agent.

The evaluation unit 408 performs an evaluation process for evaluating a willingness of a user to continue an interaction based on an input to the input unit 404. For example, the evaluation unit 408 evaluates whether the user is willing to continue an interaction (is bored) based on the user's utterance input to the input unit 404 in response to the response transmitted to the terminal apparatus 10 by the output unit 407. Specific examples of the evaluation process performed by the evaluation unit 408 will be described in multiple embodiments. The willingness to continue an interaction is a willingness of a user to continue an interaction with an interactive agent.

The response control unit 409 performs a response control process (i.e., a response process) for outputting a response related to ending an interaction based on an evaluation result obtained by the evaluation unit 408. The response control unit 409 is an example of a response unit. For example, the response control unit 409 determines whether to end a current interaction based on the evaluation result obtained by the evaluation unit 408 and a threshold value that changes as the interaction progresses. For example, when the evaluation unit 408 evaluates the user as being bored of the current interaction, the response control unit 409 determines whether to end the current interaction and outputs a response related to ending the interaction. For example, the response control unit 409 outputs a message for ending the interaction or a message proposing ending the interaction to the user. Examples of the message for ending the interaction include "I'll be ending this interaction shortly". Examples of the message proposing ending the interaction to the user include "Shall we end our interaction soon?". The message for ending the interaction and the message proposing ending the interaction to the user are each an example of a response proposing ending the interaction to the user.

The response control unit 409 may determine whether to change the topic of the current interaction based on the evaluation result obtained by the evaluation unit 408 and a threshold value that changes as the interaction progresses.

The updating unit 410 performs an updating process for updating user information on a user based on an interaction history in a case where an interaction with the user ends. For example, the updating unit 410 updates the system use state (such as the use date and time, the interaction history, and the interaction history summary) of the user information 500 illustrated in FIG. 5 in a case where the interaction with the user ends. Preferably, the updating unit 410 updates the basic user information of the user information 500 illustrated in FIG. 5 based on the interaction history.

The storage unit 411 is implemented by, for example, a storage device such as the HD 204 and the HDD controller 205 and a program executed by the CPU 201. The storage unit 411 stores various types of data (or information) such as user's utterances, responses to utterances, and an interaction history, for example. The storage unit 411 may be external to the server apparatus 100.

The user information DB 412 stores the user information 500 on users who use the interactive system 1. The user information DB 412 is implemented by, for example, a storage device such as the HD 204 and the HDD controller 205 and a program executed by the CPU 201. The user information DB 412 stores, for each user, the user information 500 described in FIG. 5, for example. The user information DB 412 may be external to the server apparatus 100.

### Functional Configuration of Terminal Apparatus

The following description is given assuming that the terminal apparatus 10 has the hardware configuration illustrated in FIG. 3.

The CPU 301 of the terminal apparatus 10 executes a predetermined program stored on a storage medium, so that the terminal apparatus 10 implements functional components illustrated in FIG. 4, for example.

In the example illustrated in FIG. 4, the terminal apparatus 10 includes functional components such as an input control unit 421, a transmission unit 422, a reception unit 423, and an output control unit 424. At least one of the functional components mentioned above may be implemented by hardware.

The input control unit 421 performs an input control process for controlling input from a user. Examples of the input from a user include input of utterance text via the touch panel 320 or input of uttered voice to the microphone 314. Examples of the input from a user include input of an image of the user captured by the CMOS sensor 305 and the imaging element I/F 306 and input of a video including uttered voice of the user acquired by the microphone 314. The uttered voice may be input to a wireless microphone that performs communication via the short-range communication circuit 319 or an external microphone or external camera connected to the external device connection I/F 318.

The transmission unit 422 performs a transmission process for transmitting the input from the user to the server apparatus (information processing apparatus) 100. For example, the transmission unit 422 transmits, to the server apparatus 100, the user's utterance such as utterance text of the user, uttered voice of the user, or an image of the user acquired by the input control unit 421.

The reception unit 423 performs a reception process of receiving, from the server apparatus 100, a response to the user's utterance transmitted to the server apparatus 100 by the transmission unit 422.

The output control unit 424 performs an output control process for controlling output of a response to a user. For example, the output control unit 424 uses the audio input/output I/F 316 and the speaker 315 to output audio response included in the response received by the reception unit 423. The output control unit 424 may use, for example, a wireless earphone or wireless speaker that performs communication via the short-range communication circuit 319 to output the audio response.

When the response received by the reception unit 423 includes response text and an image of the interactive agent, the output control unit 424 causes the display 317 to display a display screen displaying the response text and the image of the interactive agent.

The functional configuration of the interactive system 1 illustrated in FIG. 4 is an example. For example, the terminal apparatus 10 may include the functional components included in the server apparatus 100 in FIG. 4. In this case, the terminal apparatus 10 serves as an information processing apparatus according to embodiments of the present disclosure. The terminal apparatus 10 may include at least one of the functional components included in the server apparatus 100 illustrated in FIG. 4. The functional components included in the server apparatus 100 in FIG. 4 may be distributed to multiple information processing apparatuses.

### Operation

An example of an operation of a process of an interaction control method according to embodiments of the present disclosure will be described.

### First Embodiment

### Process of Interactive System

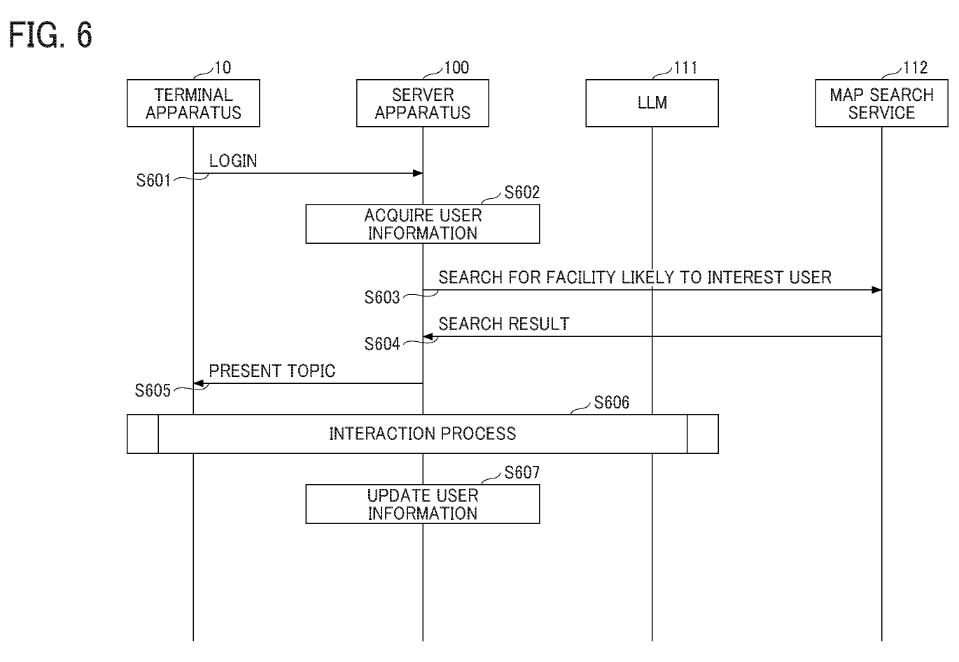

FIG. 6 is a sequence diagram illustrating an example of a process performed by the interactive system according to a first embodiment. This process is an example of a process performed by the interactive system 1 described in FIGS. 1 to 5, for example.

In step S601, the user uses the terminal apparatus 10 to log in to the server apparatus 100. In response to the login, the interactive system 1 performs processing of step S602 and subsequent steps.

In step S602, the user information acquisition unit 401 of the server apparatus 100 acquires the user information 500 on the logged-in user from the user information DB 412. The server apparatus 100 may acquire the system use state from the user information 500 illustrated in FIG. 5, and present, for example, a greeting comment such as "Hello, [user name]. We talked about [topic of last interaction] last time." to the user.

In steps S603 to S605, the presentation information generation unit 402 of the server apparatus 100 creates a topic likely to interest the user and outputs the generated topic to the terminal apparatus 10.

For example, in step S603, the presentation information generation unit 402 searches for a facility likely to interest the user using the map search service 112 based on information on the place of origin, the place of residence, and the topic that interests the user included in the user information 500 illustrated in FIG. 5. Specifically, the presentation information generation unit 402 uses an application programming interface (API) of the map search service 112 to search for a facility likely to interest the user in the map search service 112 based on the user information 500.

In step S604, the presentation information generation unit 402 acquires the facility likely to interest the user and an image of the facility from the map search service 112.

In step S605, the information presenting unit 403 of the server apparatus 100 presents, to initiate an interaction, the topic about the facility and the image of the facility acquired by the presentation information generation unit 402 to the terminal apparatus 10.

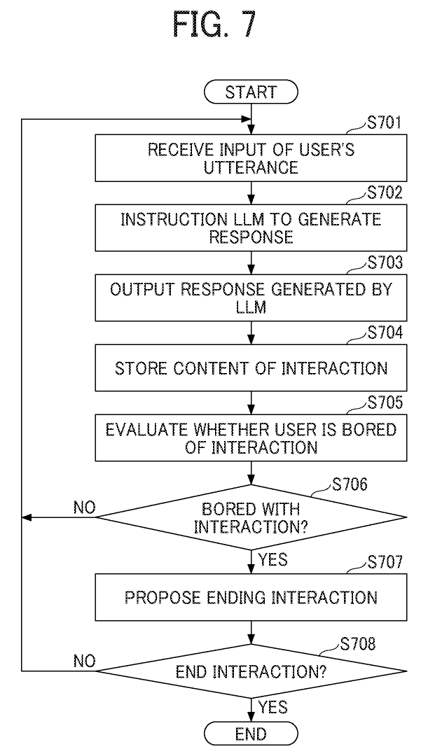

In step S606, the server apparatus 100 performs an interaction process for interacting with the user who is using the terminal apparatus 10. For example, the server apparatus 100 performs the interaction process illustrated in FIG. 7.

FIG. 7 is a flowchart illustrating an example of the interaction process according to the first embodiment. This process is an example of the interaction process performed by the server apparatus 100 in step S606 in FIG. 6, for example.

In step S701, the input control unit 421 of the terminal apparatus 10 receives input of an utterance from the user, and the transmission unit 422 of the terminal apparatus 10 transmits the user's utterance to the server apparatus 100. The server apparatus 100 receives the user's utterance from the terminal apparatus 10 and the input unit 404 receives input of the user's utterance. Then, the server apparatus 100 performs processing of step S702 and subsequent steps. When the input user's utterance is audio data, the speech recognition unit 405 converts the user's utterance into text.

In step S702, the response generation unit 406 instructs the LLM 111 to generate a response to the user's utterance. The instruction includes the content of the user's utterance and at least part of the basic user information. The response generation unit 406 generates a response to the user's utterance by acquiring the response generated by the LLM 111.

In step S703, the output unit 407 outputs the response generated by the response generation unit 406 to the terminal apparatus 10.

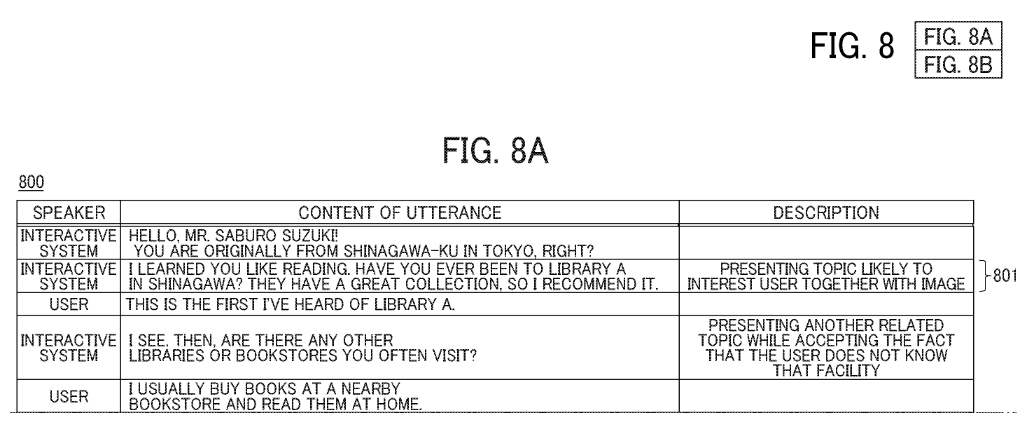

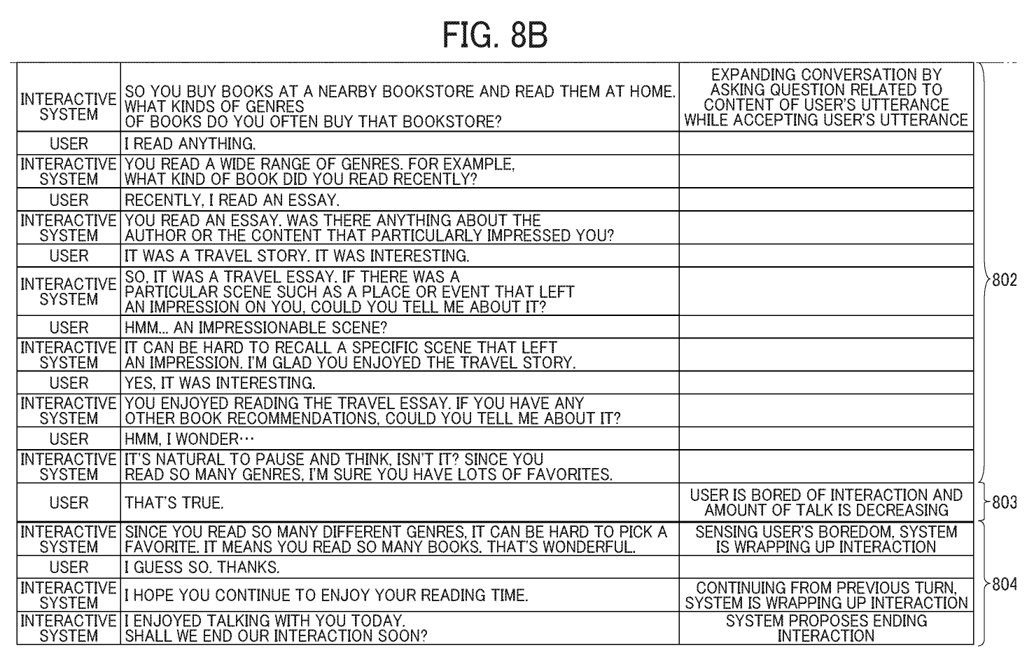

In step S704, the server apparatus 100 stores the content of the interaction in steps S701 to S703. For example, the input unit 404 stores the user's utterance input from the terminal apparatus 10 in an interaction history 800 illustrated in FIG. 8. The output unit 407 stores the response output to the terminal apparatus 10 in the interaction history 800.

In step S705, the evaluation unit 408 performs the evaluation process of evaluating whether the user is bored of the topic based on the interaction history 800. Specific processing details of the evaluation process will be described in detail in fourth and fifth embodiments.

In step S706, the response control unit 409 determines whether the user is bored of the interaction based on the evaluation result obtained by the evaluation unit 408. If the user is not bored of the interaction, the response control unit 409 returns the process to step S701 to continue the interaction. If the user is bored of the interaction, the response control unit 409 causes the process to proceed to step S707.

When the process proceeds to step S707, the response control unit 409 proposes ending the interaction to the user. For example, the response control unit 409 outputs a message wrapping up the interaction and proposing ending the interaction to the terminal apparatus 10 via the output unit 407. For example, the response control unit 409 outputs, as the message proposing ending the interaction, a message "Shall we end our interaction soon?".

In step S708, the response control unit 409 determines whether to end the interaction. For example, when the user desires to end the interaction, the response control unit 409 determines to end the interaction. When the user desires to continue the interaction, the response control unit 409 determines not to end the interaction. When the response control unit 409 determines not to end the interaction, the response control unit 409 returns the process to step S701 to continue the interaction. When the response control unit 409 determines to end the interaction, the response control unit 409 ends the interaction process illustrated in FIG. 7.

Referring back to FIG. 6, the description of the sequence diagram is continued. After the interaction process in step S606 ends, the server apparatus 100 performs processing in step S607.

In step S607, the updating unit 410 updates the user information. For example, the updating unit 410 adds, to the user information 500 illustrated in FIG. 5, information on the use date and time and the interaction history included in the system use state of the user information 500. The updating unit 410 may change or delete the user information.

When the interactive system 1 according to the present embodiment is used for a care purpose, steps below may be added as a function for checking a psychological state of a care recipient.
1) An item "matters to be checked by caregivers" is created in the "system use state" of the user information 500 illustrated in FIG. 5.
2) The updating unit 410 determines, for example, using the LLM 111 or a text search, whether user's utterances include any negative comment or whether the same topic as a topic of the previous interactions is repeated at the end of the interaction, and records the determination result in the "matters to be checked by caregivers".

There is a system that creates a care record from content of an interaction with a user. A technique used in this system focuses on a user's physical discomfort (e.g., did not sleep well or frequently went to the restroom) and conducts an interaction based on a guidance scenario for filling out predefined items of the care record. In contrast, the method based on the steps 1) and 2) described above is expected to provide an effect that allows the user's physical discomfort to be estimated from a natural small-talk-like interaction.

### Example of Interaction History

FIG. 8 is a diagram illustrating an example of the interaction history according to the first embodiment. The interaction history 800 is an example of the interaction history obtained when the interactive system 1 interacts with a user in accordance with the process of the interactive system 1 described in FIGS. 6 and 7.

Note that pieces of information such as "name: Saburo Suzuki", "place of origin: Shinagawa-ku, Tokyo", and "hobby: reading" are registered in the user information 500 of the user.

In the interaction history 800 illustrated in FIG. 8, a history record 801 corresponds to the processing in step S605 in FIG. 6. The interactive system 1 provides the user with a topic likely to interest the user together with an image.

History records 802 to 804 correspond to the interaction process illustrated in FIG. 7. The interactive system 1 determines to continue the interaction based on the history record 802. When the interactive system 1 determines that the user is bored of the interaction based on the history record 803, the interactive system 1 wraps up the interaction and proposes ending the interaction to the user on the history record 804.

### Second Embodiment

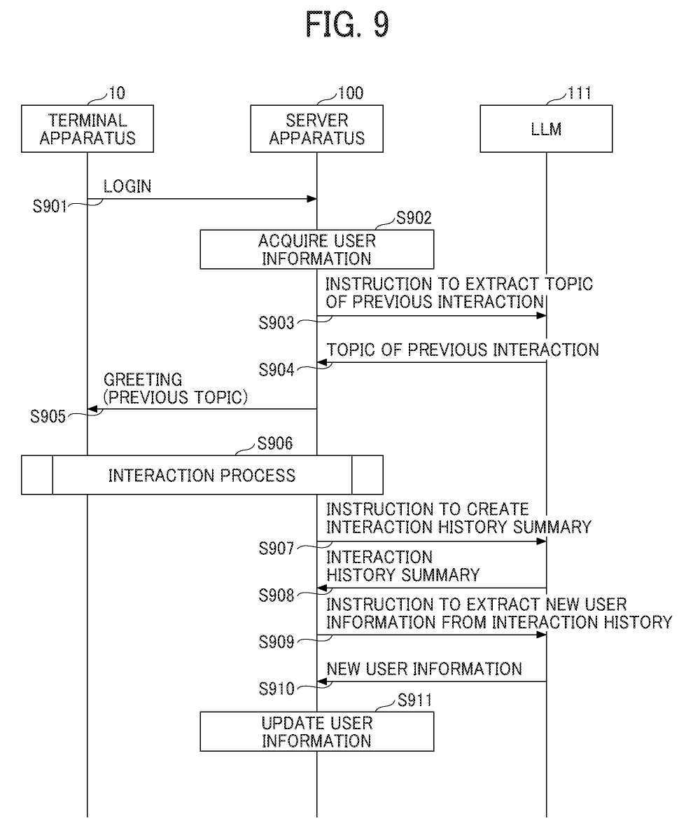

FIG. 9 is a sequence diagram illustrating an example of a process performed by an interactive system according to a second embodiment. This process is another example of a process performed by the interactive system 1 described in FIGS. 1 to 5, for example. Basic content of the process is substantially the same as that of the process of the interactive system 1 according to the first embodiment described in FIG. 6. Thus, the detailed description of substantially the same processing content as that in the first embodiment is omitted.

In step S901, the user uses the terminal apparatus 10 to log in to the server apparatus 100. In response to the login, the interactive system 1 performs processing of step S902 and subsequent steps.

In step S902, the user information acquisition unit 401 of the server apparatus 100 acquires the user information 500 on the logged-in user from the user information DB 412.

In step S903, the presentation information generation unit 402 of the server apparatus 100 inputs the interaction history or the interaction history summary included in the user information 500 illustrated in FIG. 5 to the LLM 111 and instructs the LLM 111 to extract the topic of the previous interaction, for example.

In step S904, the presentation information generation unit 402 acquires the topic of the previous interaction generated by the LLM 111.

In step S905, the information presenting unit 403 of the server apparatus 100 outputs a greeting message including the topic of the previous interaction to the terminal apparatus 10 to initiate an interaction. For example, the information presenting unit 403 presents a greeting comment such as "Hello, Mr./Ms. [user name]. We talked about [topic of last interaction] last time." to the user.

In step S906, the server apparatus 100 performs the interaction process described in FIG. 7, for example. After the interaction process in step S906 ends, the server apparatus 100 performs processing of step S907 and subsequent steps.

In step S907, the updating unit 410 inputs the interaction history 800 illustrated in FIG. 8 to the LLM 111 and instructs the LLM 111 to generate the interaction history summary, for example. In step S908, the updating unit 410 acquires the interaction history summary generated by the LLM 111.

In step S909, the updating unit 410 inputs the interaction history 800 illustrated in FIG. 8 to the LLM 111 and instructs the LLM 111 to extract new user information, for example. For example, the updating unit 410 instructs the LLM 111 to extract, from the interaction history 800, yet-to-be-registered information of information included in the basic user information of the user information 500 illustrated in FIG. 5. In step S910, the updating unit 410 acquires the new user information extracted by the LLM 111.

In step S911, the updating unit 410 updates the user information. For example, the updating unit 410 adds, to the user information 500, information such as the use date and time and the interaction history included in the system use state of the user information 500 illustrated in FIG. 5.

The updating unit 410 adds the interaction history summary acquired in step S908 to the interaction history summary included in the system use state of the user information 500. This interaction history summary is used in a case of the next login of the user, for example. When the content of the previous interaction is utilized in utterances generated by the interactive system 1, embedding the interaction history summary in the prompt, rather than embedding the interaction history in the prompt, can save the number of tokens and make the content of the prompt concise. This increases the response accuracy of the LLM 111. When the interactive system 1 according to the present embodiment is used for a care purpose, the summarized interaction history makes it easier for caregivers to grasp the system use state of care recipients.

The updating unit 410 adds the new user information acquired in step S910 to the basic user information of the user information 500. Preferably, the response generation unit 406 uses the basic user information, which is a brief summary of the user information, to generate a response. Thus, the response generation unit 406 can continue to refer to the information spoken by the user in the previous interaction while keeping the number of tokens low.

For example, when all the interaction history, whose information continues to increase because of multiple uses of the interactive system 1, is embedded in the prompt, token consumption increases and response conciseness decreases. On the other hand, when the content of several recent interactions is embedded in the prompt, the interactive system 1 cannot grasp the content spoken by the user before. In contrast, in generation of a response by embedding the basic user information in the prompt, since the features of the content of the hitherto interactions are extracted and used, information consistency can be maintained while keeping the number of tokens low.

For example, a wide variety of information such as the user's hobby, interest, experience, and desire is extracted from the interaction based on the basic user information of the user information 500 illustrated in FIG. 5. Such information can be flexibly used in responses for various topics.

In the future, the server apparatus 100 may devise original attributes based on the basic user information. For example, for a user with "hobby: baseball", the server apparatus 100 may add a subdivided attribute such as "favorite baseball team" or "baseball experience and memories" and thus cope with the individual hobby and interest more finely.

### Third Embodiment

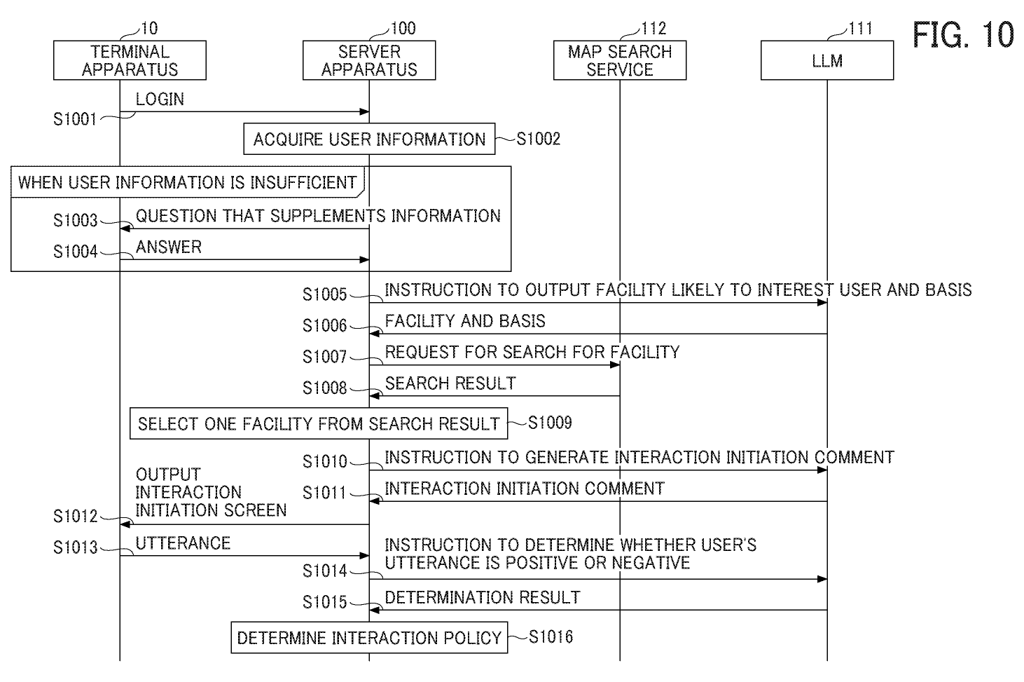

FIG. 10 is a sequence diagram illustrating an example of an interaction initiation process according to a third embodiment. This process is an example of a specific process of the process (interaction initiation process) described in steps S601 to S605 in FIG. 6, for example.

In step S1001, the user uses the terminal apparatus 10 to log in to the server apparatus 100. In response to the login, the interactive system 1 performs processing of step S1002 and subsequent steps.

In step S1002, the user information acquisition unit 401 of the server apparatus 100 acquires the user information 500 on the logged-in user from the user information DB 412.

When the user information 500 lacks information to be used, the server apparatus 100 performs processing in steps S1003 and S1004. Examples of the information to be used include information such as (A) user's place of origin or place of residence and (B) user's hobby, likes, or topic of interest.

In steps S1003 and S1004, the user information acquisition unit 401 of the server apparatus 100 transmits a question that supplements the lacking information to the terminal apparatus 10 and receives an answer transmitted by the terminal apparatus 10 to acquire the user information to be used. When the user information to be used is registered in the user information 500, the user information acquisition unit 401 does not perform the processing in steps S1003 and S1004.

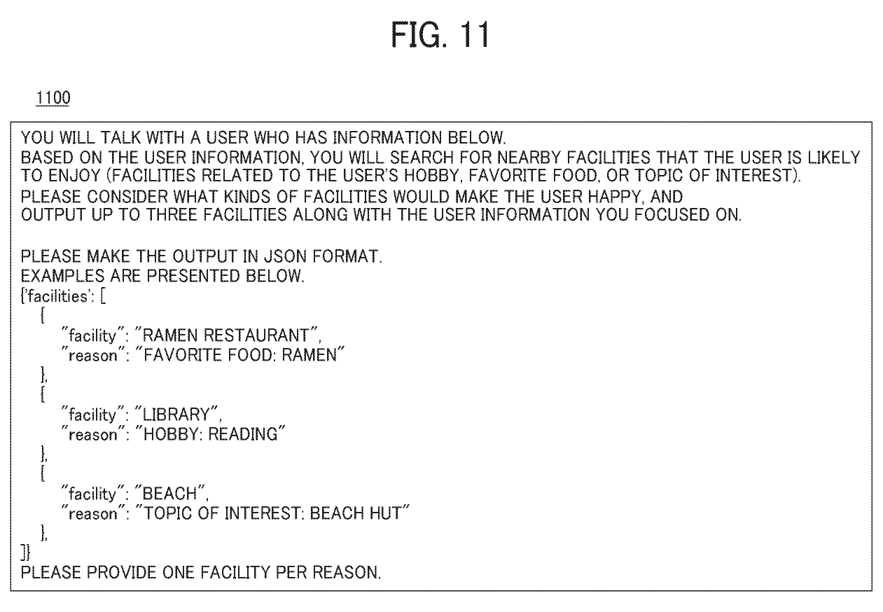

In step S1005, the presentation information generation unit 402 of the server apparatus 100 instructs the LLM 111 to output the facility likely to interest the user and a basis thereof. For example, the presentation information generation unit 402 transmits a prompt 1100 illustrated in FIG. 11 to the LLM 111 together with the user information. The prompt 1100 instructs the LLM 111 to output the facility related to the user's hobby or likes and the user information serving as a basis thereof. In response to the instruction, the LLM 111 outputs information on a facility likely to interest the user (e.g., a soccer stadium, a curry restaurant, etc.) and the user information serving as a basis for selecting the facility (e.g., "the user's hobby is soccer", "the user likes curry", etc.) in the JavaScript Object Notation (JSON) format.

In step S1006, the presentation information generation unit 402 of the server apparatus 100 acquires the information on the facility likely to interest the user and the user information serving as the basis for selecting the facility, which are output by the LLM 111.

In step S1007, the presentation information generation unit 402 of the server apparatus 100 requests the map search service 112 to search for a facility. For example, the presentation information generation unit 402 uses the API provided by the map search service 112 to request the map search service 112 to perform a search based on "name of place of origin + facility likely to interest the user".

In step S1008, the presentation information generation unit 402 of the server apparatus 100 acquires the search result. Preferably, the presentation information generation unit 402 excludes a facility whose address does not include the name of the place of origin from the search result.

In step S1009, the presentation information generation unit 402 of the server apparatus 100 selects one facility to be presented to the user out of the search result. For example, the presentation information generation unit 402 extracts top 10 facilities in the descending order of the number of reviews from among the facilities included in the search result, randomly selects one facility from the extracted facilities, and acquires an image of the selected facility. Any number of facilities may be extracted.

In step S1010, the presentation information generation unit 402 of the server apparatus 100 instructs the LLM 111 to generate an interaction initiation comment. For example, the presentation information generation unit 402 includes the following information in a prompt and instructs the LLM 111 to generate an interaction initiation comment.

An instruction to respond to the user's utterance "I'm from [name of place of origin]"

Information on the facility and the basis acquired in step S1006

A fact that the facility selected in step S1009 is in an area of the user's place of origin.

In step S1011, the presentation information generation unit 402 of the server apparatus 100 acquires the interaction initiation comment generated by the LLM 111.

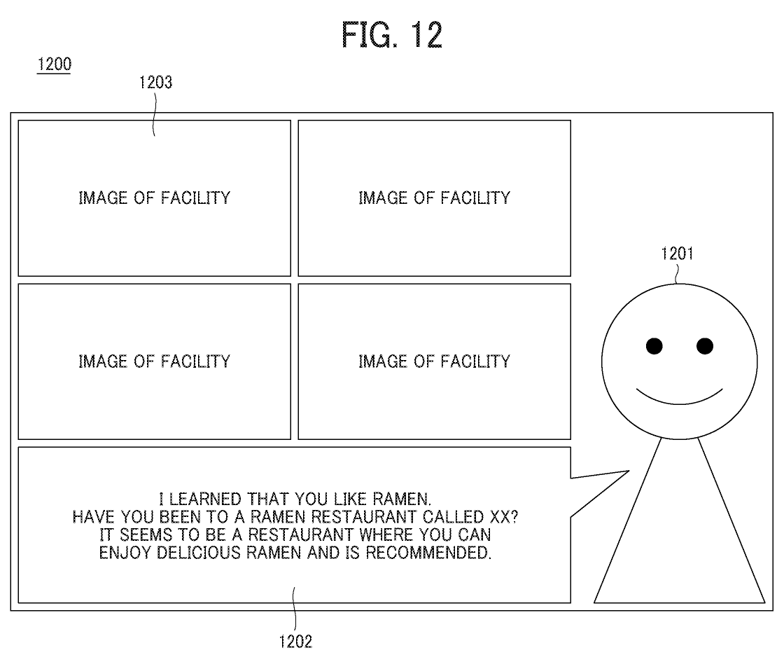

In step S1012, the information presenting unit 403 of the server apparatus 100 transmits an interaction initiation screen including the image of the facility selected in step S1009 and the interaction initiation comment acquired in step S1011 to the terminal apparatus 10. Consequently, the terminal apparatus 10 displays an interaction initiation screen 1200 illustrated in FIG. 12, for example.

FIG. 12 is a diagram illustrating an example of the interaction initiation screen according to the third embodiment. In the example illustrated in FIG. 12, the interaction initiation screen 1200 displays an interactive agent 1201 that interacts with the user, an interaction initiation comment 1202 acquired in step S1011 illustrated in FIG. 10, and an image 1203 of the facility selected in step S1009 illustrated in FIG. 10. Desirably, multiple different images 1203 of the facility are displayed because the user may find it difficult to imagine the facility from a single image.

The interaction initiation screen 1200 provides images of the nearby facility that interests the user, and thus can increase the effects of reminiscence therapy.

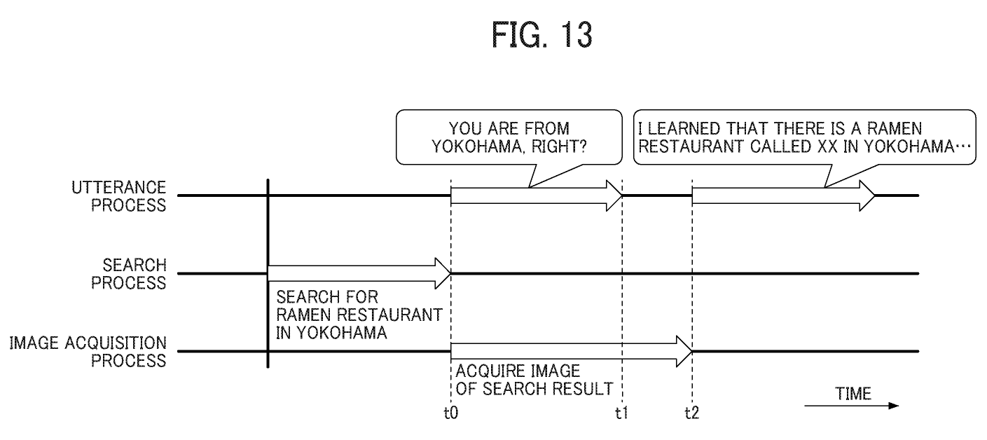

Since acquisition of images takes time, to reduce a perceived waiting time of the user, the server apparatus 100 preferably causes, for example, an utterance such as "You are from [user's place of origin], right?" to be output at a time when the topic is determined, as illustrated in FIG. 13.

FIG. 13 is a diagram illustrating an example of a process performed when an image is acquired according to the third embodiment. In FIG. 13, the interactive system 1 searches for a ramen restaurant in Yokohama and determines the topic to be the ramen restaurant in Yokohama at time t0. The interactive system 1 takes time from the time t0 to time t2 to acquire an image for the search result (i.e., the ramen restaurant in Yokohama). In this case, the interactive system 1 outputs, for example, an utterance such as "You are from Yokohama, right?" at the time t0. This can reduce the perceived waiting time of the user from time from t0 to t2 to time from t1 to t2.

Referring back to FIG. 10, the description of the sequence diagram is continued. In step S1013, in response to the user inputting an utterance on the interaction initiation screen, the interactive system 1 performs processing of step S1014 and subsequent steps.

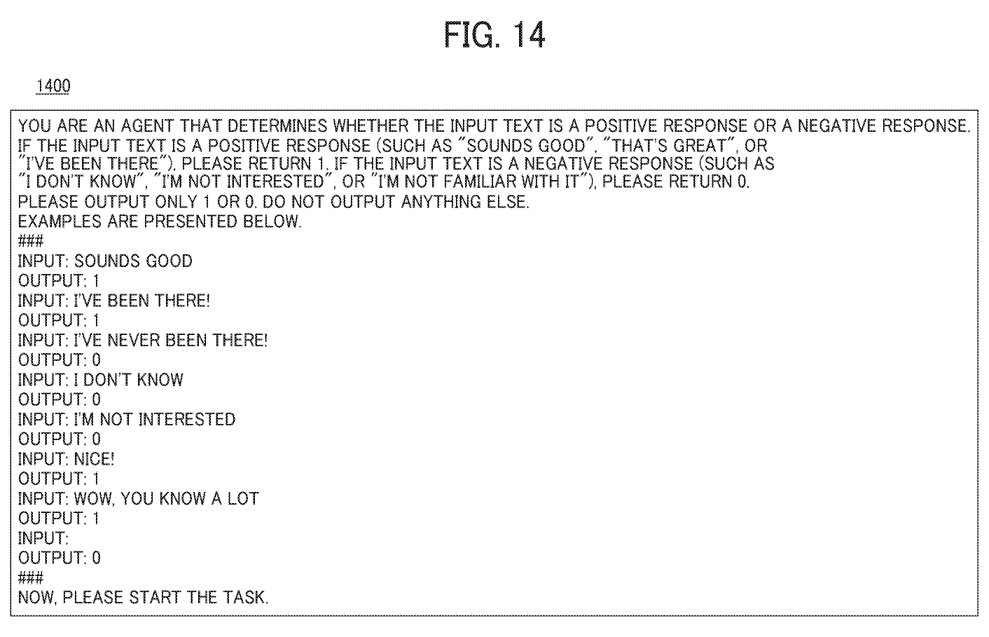

In step S1014, the evaluation unit 408 of the server apparatus 100 instructs the LLM 111 to determine whether the user's utterance for the presented topic is positive or negative. For example, the evaluation unit 408 uses a prompt 1400 illustrated in FIG. 14 to cause the LLM 111 to determine whether the user's utterance is a positive response or a negative response. In step S1015, the evaluation unit 408 acquires the determination result obtained by the LLM 111.

In step S1016, the response generation unit 406 determines the interaction policy in accordance with whether the user's utterance is a positive response or a negative response. For example, when the response of the user is positive (e.g., I've heard of that, I've been there, etc.), the response generation unit 406 uses the LLM 111 to generate a question that delves into the presented topic. For example, the response generation unit 406 generates a question such as "So you have been there. What is your favorite ramen at XX?".

When the user's utterance is negative (e.g., I didn't know it, I'm not interested), the response generation unit 406 accepts that the user is negative to the topic and uses the LLM 111 to generate a to-be-presented response related to another topic. For example, the response generation unit 406 generates a question such as "I see. Then, do you have any other recommended ramen restaurants?".

The interactive system 1 provides the topic according to the user's curiosity and interest in the process described above and provides benefits below.

Images of a nearby facility that interests the user are provided to enliven the conversation and increase the effects of reminiscence therapy.

Facilities whose address data does not include the character string of the place of origin are excluded from the search result to prevent facilities that are not located in the area of the place of origin of the user from being presented by mistake.

The search result is refined by the number of reviews to a predetermined number to prevent facilities that are not familiar to residents and equipment incidental to facilities such as a parking lot from being presented.

The facility to be presented as the topic is randomly selected to prevent the same facility and the same topic from being repeatedly presented every time and provide freshness and diversity of the interaction.

Supplementary description relating to the first to third embodiments is given.

### Topic That Interests User

In the first to third embodiments, the "facility likely to interest the user in the area of the user's place of origin" is presented as the "topic that interests the user". For example, when the user likes soccer and curry, the interactive system 1 proposes a facility such as a soccer stadium or a curry restaurant based on the information on the user's likes. Since the topic specific to the user is provided in this manner, it can be expected that the user feels that an interaction partner is interested in the user and is considerate of the user and thus can attain a higher sense of satisfaction. Instead of a general place such as a sightseeing spot, a facility that matches the user's taste and preference is presented because such a facility is considered to be more likely to attract a personal interest of the user and to allow the interaction to continue without interruption of the topic. Even when the presented facility does not interest the user, the direction of the topic matching the user's taste and preference is indicated. Therefore, it becomes easy to continue the conversation.

### Acquisition of User Information

The interactive system 1 acquires, from the user information DB 412, pieces of user information as follows:

Place of origin or place of residence; and

Other information.

These pieces of information are acquired from the "basic user information" of the user information 500 described above. At least one of the place of origin or the place of residence is acquired as the "place of origin or place of residence" from the basic user information. The rest of the basic user information serves as the "other information". The "other information" is used for estimating a facility likely to interest the user in later steps. The "other information" also includes information (e.g., the occupation or dislikes) that is not to be used in selection of the facility. Since such information is excluded in the later steps, the accuracy in setting the topic is maintained.

### Method for Estimating Topic Likely to Interest User

The interactive system 1 uses the LLM 111 to estimate a facility likely to interest the user. For example, the interactive system 1 provides the LLM 111 with the "other information" acquired from the user information 500 and refines user information to be focused on with a prompt "Please present facilities related particularly to the user's hobby, favorite food, and topic of interest". Thus, the interactive system 1 can prevent facilities irrelevant to the interest of the user from being presented.

At this time, information on the user's occupation is desirably excluded from reference information used at the time of topic selection.

For example, the LLM 111 is more likely to conclude that stationery shops are related facilities for an occupation of office clerk. However, not all office clerks are interested in stationery shops. As described above, it is difficult to accurately narrow the range of the user's curiosity and interest based on the occupation information. Likewise, information on the user's age and dislikes of the "other information" is preferably excluded from the reference information used at the time of topic selection. The interactive system 1 sets the topic based on the user's curiosity and interest by preferentially using information on the hobby and interest instead of referring directly to the occupation information.

### Method for Searching for and Selecting Topic

The interactive system 1 uses the map search service 112 to search for facilities based on search words, namely, the "name of the user's place of origin" and "facilities likely to interest the user", for example. In this method, the search result may include, for example, "facilities located in a neighboring area of the specified area", "facilities that are not familiar to residents", and "equipment (e.g., a parking lot) incidental to facilities". Thus, the interactive system 1 desirably performs a process described below to narrow down the facilities so that facilities likely to interest the user can be presented. The topic likely to interest the user (i.e., the topic related to the user information) is a search result satisfying a predetermined condition among the search results obtained using the user information, for example.

It is checked whether the address data of each search result includes the character string of the name of the place of origin, and a facility whose address data does not include the character string is regarded as not existing in the specified area and is excluded.

The numbers of reviews of the respective search results are compared, and top ten search results are adopted in descending order of the number of reviews. This is because it is considered that facilities that are not familiar to residents and equipment incidental to facilities have few reviews.

One facility is randomly selected from among the ten facilities that have been narrowed down and set as a topic to be presented to the user. In this manner, the same facility can be prevented from being presented as the topic every time a user with less user information interacts with the interactive system 1. For example, when "the user is from Yokohama-shi, Kanagawa and likes ramen" is registered as the user information and a facility having the largest number of reviews is presented every time, it is highly likely that the interactive system 1 presents the fixed ramen restaurant in Yokohama as the topic every time.

### Generation of Interaction Initiation Comment

After the topic (i.e., the facility of the search result) to be presented to the user and images of the facility are prepared, the interactive system 1 uses the LLM 111 to generate the interaction initiation comment. The prompt for instructing the LLM 111 to generate the interaction initiation comment preferably includes information below.

A request to consider a response to the user's utterance "I'm from [name of place of origin]".

A set of "facilities likely to interest the user" used in a facility search and "user information serving as a basis for selecting the facilities".

A fact that the facility selected as the search result is in the area of the user's place of origin. For example, for a user having prior information such as "is from Yokohama-shi, Kanagawa and likes ramen", an interaction initiation comment such as "I learned that you like ramen. Have you been to a ramen restaurant called XX? It seems to be a restaurant where you can enjoy delicious ramen and is recommended." is generated. Consequently, the user can feel that "a topic personalized to the user is presented" or that "the interactive system 1 is interested in what the user likes".

### Effort to Provide Topic Better Matching User's Interest

It is conceivable that storing information below in the user information DB 412 at the end of an interaction to utilize the information as data for more accurately grasping the user's interest and effectively proposing the topic that interests the user in the future.

The presented topic (the facility name and the user information referred to)

The presented images

The search word used during the topic search

The number of turns continued for the topic in the interaction

The user's reaction to the topic (e.g., positive reactions such as "You know it well" or negative reactions such as "That story again?")

### Evaluation Process

Examples of a specific evaluation process for evaluating a willingness of a user to continue an interaction (e.g., whether the user is bored of the interaction) will be described.

### Fourth Embodiment

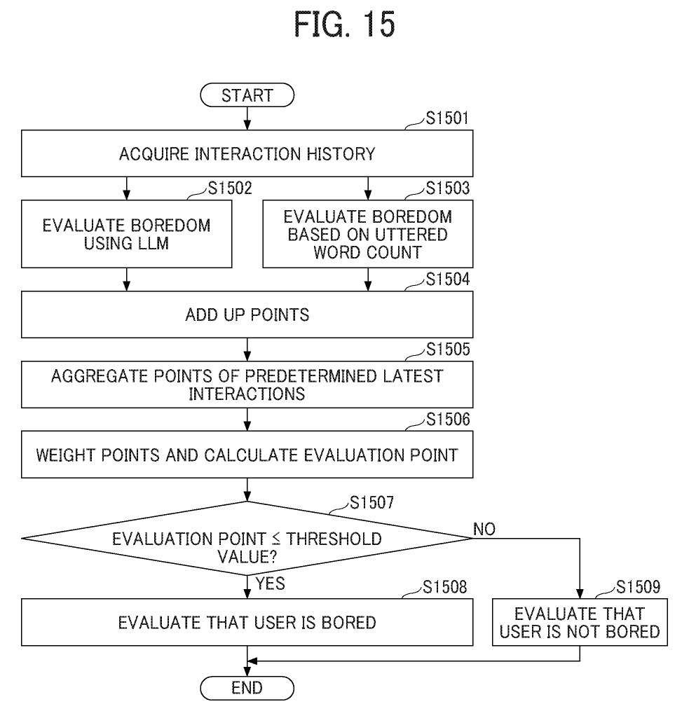

FIG. 15 is a flowchart illustrating an example of the evaluation process according to the fourth embodiment. This process is an example of the processing performed by the server apparatus 100 to evaluate whether the user is bored (whether the user is willing to continue the interaction) in step S705 in FIG. 7, for example. The state in which "a user is bored of an interaction" is a state where the user is not (or is estimated not to be) willing to continue the interaction with the interactive system 1.

For example, the state in which "a user is bored of an interaction" refers to a state where the user appears to be tired of the utterances of the interactive system 1 or appears to want to end the interaction.

In step S1501, the evaluation unit 408 of the server apparatus 100 acquires an interaction history between the user and the interactive system 1.

In step S1502, the evaluation unit 408 uses the LLM 111 to evaluate the user's boredom. For example, the evaluation unit 408 inputs a prompt including the interaction history to the LLM 111 and instructs the LLM 111 to evaluate whether the user is bored of the interaction based on the utterance of the interactive system 1. In a specific example, the evaluation unit 408 causes the LLM 111 to output a point of −1 when the user is bored and to output a point of +1 when the user is not bored. This point is an example of a first evaluation result of evaluating a willingness of a user to continue an interaction (first willingness to continue an interaction) obtained by inputting the interaction history (content of the interaction) to a large language model. The point may be a positive value when the user is bored and a negative value when the user is not bored.

In this process, the past interaction history is embedded in the prompt, so that boredom is estimated by taking into account the context and the way the user speaks. For example, suppose that the user makes an utterance "I read a novel". When the previous utterance made by the interactive system 1 is "What kind of book did you read?", that is, when the user's utterance follows the context up to that point, it can be estimated that the user is highly likely not bored. On the other hand, when the previous utterance made by the interactive system 1 is "Do you have a favorite drink?", the user's utterance does not follow the context. Thus, it can be estimated that the user is highly likely bored.

In step S1503, the evaluation unit 408 evaluates the user's boredom based on an uttered word count. For example, the evaluation unit 408 monitors whether the average value of the uttered word counts for the last several utterances including the immediately preceding utterance is decreasing to estimate boredom from the viewpoint of whether the amount of talk by the user is decreasing.

For example, when children are bored of play, characteristics such as the amount of talk decreasing, facial expressions becoming expressionless, behavior becoming slow, and paying attention to other things are observed. It is considered that similar characteristics appear when adults are bored of an interaction. In the present embodiment, among these characteristics, whether "the amount of talk is decreasing", which can be determined based on uttered comments without using any special device such as a camera, is focused on, and a method for monitoring a change in the uttered word count of the user is devised. In this method, it is determined whether the amount of talk by the user is decreasing based on comparison between the average values of uttered word counts. Note that boredom is estimated not based on the uttered word count of the current utterance but based on the average value including the uttered word count of the immediately preceding utterance. This reduces the influence of the abrupt long talk or short interjection.

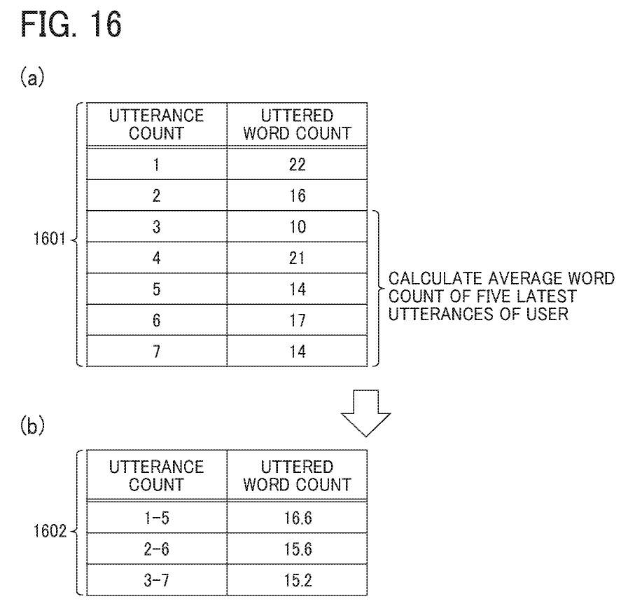

FIG. 16 is a diagram for describing the evaluation based on the uttered word count according to the fourth embodiment. The evaluation unit 408 acquires an uttered word count 1601 for each utterance made by the user, calculates an average uttered word count of the latest five utterances made by the user, and stores the average uttered word count in a list 1602. The list 1602 is updated each time the user makes an utterance, and the average uttered word count for the latest five utterances is added each time.

The evaluation unit 408 checks whether the value of the uttered word count in the list 1602 is continuously decreasing. When the value of the uttered word count is continuously decreasing, the evaluation unit 408 determines that the amount of talk by the user is decreasing and estimates that the user is bored of the interaction. For example, when the amount of talk by the user is decreasing, the evaluation unit 408 sets the point to −1. When the amount of talk by the user is not decreasing, the evaluation unit 408 sets the point to +1. This point is an example of a second evaluation result of evaluating a willingness of a user to continue an interaction (second willingness to continue an interaction) obtained based on the uttered word count of the user.

The point may be a positive value when the amount of talk by the user is decreasing and a negative value when the amount of talk by the user is not decreasing.

The evaluation of "boredom" in steps S1502 and S1503 is an example of evaluating whether the user is willing to continue an interaction. For example, the evaluation unit 408 may evaluate whether a user is willing to continue an interaction based on another index such as whether the user is feeling dull or whether the user is annoyed, for example.

In step S1504, the evaluation unit 408 adds up the points obtained in the evaluation in steps S1502 and S1503.

In step S1505, the evaluation unit 408 aggregates the points for a predetermined number of latest times (e.g., five times). For example, the evaluation unit 408 creates data [0, 2, −2, −2, 2] sequentially from the oldest point.

In step S1506, the evaluation unit 408 weights the aggregated points for the predetermined number of times to calculate an evaluation point. For example, the evaluation unit 408 weights the aggregated points such that a later utterance is weighted more. For example, the evaluation unit 408 sets weights [0.5, 0.75, 1, 1.5, 1.75] sequentially from the oldest point so that the latest point is weighted more, and adds up the weighted points for the predetermined number of times to calculate the evaluation point.

In step S1507, the evaluation unit 408 determines whether the calculated evaluation point is less than or equal to a threshold value (e.g., "−3"). In this specific example, since the more the evaluation point is large in a negative direction, the more negative the evaluation becomes (e.g., the user is bored or the amount of talk is decreasing), it is determined whether the evaluation point is less than or equal to the threshold value. When the more the evaluation point is large in a positive direction, the more negative the evaluation becomes (e.g., the user is bored or the amount of talk is decreasing), it may be determined whether the evaluation point is greater than or equal to a threshold value.

Preferably, this threshold value dynamically changes based on time information based on the progress of the interaction such as the utterance turn count in the entire interaction (or the duration of the interaction) or the duration of the same topic.

For example, when the interaction continues for the same topic for a long time, the threshold value is lowered so that it is more likely to determine that the user is bored. This can prevent the same topic from continuing endlessly unintentionally and the user from becoming bored. On the other hand, when the user desires to continue the interaction about the same topic, the topic is continued naturally by the user talking positively. Lowering the threshold value refers to changing the threshold value to make it more likely to determine that the user is bored. When the larger the evaluation point is in the negative direction, the more negative the evaluation becomes (e.g., the user is bored or the amount of talk is decreasing), the threshold value is changed in the positive direction. When the larger the evaluation point is in the positive direction, the more negative the evaluation becomes, the threshold value is changed in the negative direction. The utterance turn count refers to a number of exchanges of responses between the user and the interactive system 1.

When the system makes an initial utterance and the user responds to the utterance, the utterance turn count is 1. When the system subsequently responds to the user's response, the utterance turn count is 2.

When the evaluation point is less than or equal to the threshold value (YES in step S1507), the process proceeds to step S1508 in which the evaluation unit 408 evaluates that the user is bored of the interaction. When the evaluation point is not less than or equal to the threshold value (NO in step S1507), the process proceeds to step S1509 in which the evaluation unit 408 determines that the user is not bored of the interaction.

As described above, in the present embodiment, boredom of the user is determined using two methods, i.e., the method for estimating boredom of the user using the LLM 111 and the method for monitoring a change in the uttered word count of the user. The two methods are used in combination to mutually compensate disadvantages of the respective methods and implement the interactive system 1 with fewer erroneous determinations.

Regarding disadvantages of the method for estimating the user's boredom by using an LLM, it is considered that a machine learning model can determine the user's boredom at relatively high accuracy if a vast amount of training data is collected and learned as in a technique in the related art, for example. However, when the machine learning model is implemented at low cost by using the existing LLM 111, the accuracy of determination decreases as compared with a model specialized in determination of boredom.

Regarding disadvantages of the method for monitoring the change in the uttered word count of the user, for example, when the user makes a short response such as a short interjection, the uttered word count decreases. Therefore, it is more likely to be erroneously determined that the user is bored even though the user has the intention to continue the interaction.

In the present embodiment, two simple and low-cost methods are used to determine boredom. However, the determination accuracy may be further increased by additionally using the following methods in combination in the future. This allows the interactive system 1 to capture the user information from multiple viewpoints and is less likely to miss boredom.

Estimation from Facial Expression and Posture: The interactive system 1 analyzes the user's facial expression, face orientation, posture change, and the like by using a video obtained by the camera. For example, the interactive system 1 can determine that the user is likely to be bored when the user averts the eyes from a screen or when the user's posture becomes collapsed.

Speech emotion recognition: The interactive system 1 analyzes the emotion of the user from uttered voice of the user, and regards a high possibility of boredom when the negative emotion is continuously observed. It is considered that signs of boredom can be grasped from a manner of speaking as well as content of utterances when a tone and tempo of voice exhibits a certain tendency.

The evaluation process according to the fourth embodiment is expected to provide effects below, for example.

The use of the two methods in estimation of boredom can reduce the erroneous determination of boredom because even when one of the methods fails to estimate boredom, this can be supplemented by the other method.

Boredom is determined by adding the "points" in the interaction for the latest predetermined number of times, that is, in consideration of time information, immediate determination that the user is bored when the user makes a short interjection, for example, can be prevented.

Since a new model is not created, implementation can be easily made at low cost by using the existing LLM 111.

Any values can be set for the weight and the threshold value used for determining the user's boredom. For example, this makes it easier to grasp a basis for determination of boredom and fine adjustment can be made appropriately during debugging. The design is made flexibly to successfully cope with various user characteristics and manners of speaking not depending on a specific setting.

### Fifth Embodiment

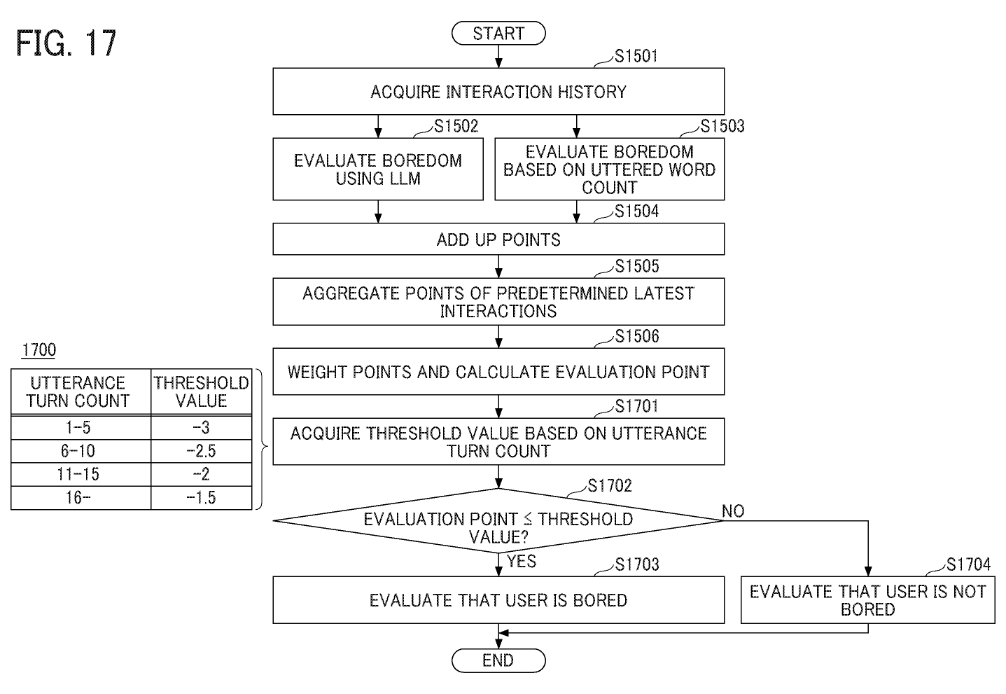

FIG. 17 is a flowchart illustrating an example of the evaluation process according to the fifth embodiment. This process is another example of the processing performed by the server apparatus 100 to evaluate whether the user is bored (whether the user is willing to continue the interaction) in step S705 in FIG. 7, for example. Since processing of steps S1501 to S1506 of the process illustrated in FIG. 17 is substantially the same as that of the evaluation process according to the fourth embodiment described with reference to FIG. 15, description thereof is omitted.

In step S1701, the evaluation unit 408 acquires the threshold value corresponding to the utterance turn count. For example, as illustrated in FIG. 17, the server apparatus 100 stores correspondence information 1700 indicating a correspondence between the utterance turn count and the threshold value in the storage unit 411 in advance. Thus, the evaluation unit 408 can acquire the threshold value corresponding to the current utterance turn count from the correspondence information 1700.

As illustrated in FIG. 17, the correspondence information 1700 is set such that as the utterance turn count increases, the threshold value increases and it becomes more likely to determine boredom. This threshold value is a specific example of the threshold value that changes as the interaction progresses.

In step S1702, the evaluation unit 408 determines whether the calculated evaluation point is less than or equal to the threshold value acquired in step S1701. When the evaluation point is less than or equal to the threshold value (YES in step S1702), the process proceeds to step S1703 in which the evaluation unit 408 evaluates that the user is bored of the interaction. When the evaluation point is not less than or equal to the threshold value (NO in step S1702), the process proceeds to step S1704 in which the evaluation unit 408 determines that the user is not bored of the interaction.

In the example of FIG. 17, the threshold value is determined based on the utterance turn count. In the future, a function may be added to automatically adjust parameters such as the threshold value or the weight in accordance with the user's interaction pattern or manner of speaking, for example. For example, the server apparatus 100 stores the threshold value or the weight according to the user's interaction tendency in a database and uses parameters optimized for each user in determination of boredom. Thus, the server apparatus 100 can highly accurately determine a degree of boredom of the user. Thus, it is expected that customization of the parameters provides flexible response in accordance with preferences of each user.

Regarding a method for determining boredom in consideration of the progress of the interaction, the threshold value for determining boredom is decreased based on the time information in this case. However, the weight value used when boredom points are added may be changed based on the time information. That is, the weight value may change as the interaction progresses. In this case, the weight value is increased when the interaction continues for the same topic for a long time, so that it is more likely that the total point exceeds the threshold value and consequently the user is determined to be bored.

### Effort to Continue Interaction with User who Feels Bored

In the future, when it is determined that a user is bored of the interaction, instead of immediately ending the interaction, continuation of the interaction may be attempted by methods below, for example.

### Provision of News According to Interest

The interactive system 1 may acquire the latest news or topic likely to interest the user from an external information source and provides the latest news or topic as a theme of an interaction to add freshness to the interaction and attempt to continue the interaction.

### Presentation of New Topic Using Related Images

The interactive system 1 may attempt to continue the interaction by visually interesting the user and encouraging interest in the interaction by displaying related images when a new topic is proposed.

### Generation of Topic Using Real-Time Video

The interactive system 1 acquires a video of an area around the user with a camera and generates a topic from an event at the place. This enables a natural interaction about an event actually occurring around the user as the topic. For example, by performing an interaction following a circumstance of the user, such as making a comment on weather or clothing so that the user feels familiarity and thereby drawing out willingness for the interaction, the interactive system 1 may attempt to continue the interaction. For example, the interactive system 1 presents a topic such as "It seems to have become a little brighter around you. Has the rain stopped?" or "You are wearing a red shirt today, and it suits you very well. Where did you buy it?".

The interactive system 1 may further reduce an influence of boredom in the previous topic by, in several turns immediately after the topic is changed, decreasing boredom evaluation "points" by a fixed ratio and temporarily relaxing the threshold value for determining boredom. This method makes it easier to evaluate the interest in the new topic, and can increase a possibility that the user will become positive about the interaction again.

As described above, according to the present embodiment, the interactive system 1 that automatically responds to a user's utterance can control a response in consideration of the progress of the interaction.

The interactive system 1 according to the present embodiment is expected to provide effects below.

Since a topic matching user information is searched for and presented each time, the topic matching the user's curiosity and interest can be provided.

Since a related image is presented together with the topic, the user's attention can be prompted and slackening in the interaction can be prevented.

Since boredom is determined not by a uniform criterion for all the people or user-specific setting value but based on a change in the amount of talk of the user during each interaction, boredom can be estimated in consideration of not only the user's individuality but also the user's mood and physical condition at that time.

Since time information such as the "content of the last several utterances", the "utterance turn count in the entire interaction (interaction duration)", or the "duration of the same topic" is taken into account when boredom is estimated, boredom can be estimated in consideration of a degree of progress of the interaction. For example, an interaction is devised so that the same topic does not continue for longer than necessary.

Since a dedicated LLM is not used to estimate boredom and the existing LLM 111 is used and only text information or user behavior is used, the model can be implemented at low cost.

The functionality of the elements disclosed herein may be implemented using circuitry or processing circuitry which includes general purpose processors, special purpose processors, integrated circuits, application-specific integrated circuits (ASICs), field-programmable gate arrays (FPGAs), and/or combinations thereof which are configured or programmed, using one or more programs stored in one or more memories, to perform the disclosed functionality. Processors are considered processing circuitry or circuitry as they include transistors and other circuitry therein. In the disclosure, the circuitry, units, or means are hardware that carry out or are programmed to perform the recited functionality. The hardware may be any hardware disclosed herein which is programmed or configured to carry out the recited functionality.

There is a memory that stores a computer program which includes computer instructions. These computer instructions provide the logic and routines that enable the hardware (e.g., processing circuitry or circuitry) to perform the method disclosed herein. This computer program can be implemented in known formats as a computer-readable storage medium, a computer program product, a memory device, a record medium such as a CD-ROM or DVD, and/or the memory of an FPGA or ASIC.

The apparatuses or devices described in each embodiment are merely one example of multiple computing environments that implement one or more embodiments disclosed herein. In one embodiment, the server apparatus 100 includes multiple computing devices such as a server cluster. The multiple computing devices communicate with one another through any type of communication link including a network, a shared memory, or the like and perform the processes disclosed herein.

The functional components of the server apparatus 100 may be integrated into one server apparatus or distributed to multiple apparatuses. At least one of the functional components of the server apparatus 100 may be included in the terminal apparatus 10.

### Aspects

An information processing apparatus, an interactive system, an interaction control method, and a program below are disclosed herein.

According to Aspect 1, an information processing apparatus includes an input unit, an evaluation unit, and a response unit. The input unit receives an input from a user. The evaluation unit evaluates a willingness of the user to continue an interaction, based on the input. The response unit outputs a response related to ending the interaction, based on a result of the evaluation by the evaluation unit.

According to Aspect 2, in the information processing apparatus of Aspect 1, the response related to ending the interaction includes a response proposing ending the interaction to the user.

According to Aspect 3, in the information processing apparatus of Aspect 1 or 2, the response unit outputs the response related to ending the interaction, based on the result of the evaluation and a threshold value that changes as the interaction progresses.

According to Aspect 4, in the information processing apparatus of Aspect 3, the threshold value changes based on a duration of a same topic or an utterance turn count for the same topic.

According to Aspect 5, in the information processing apparatus of any one of Aspect 1 to 4, the evaluation unit evaluates the willingness of the user to continue the interaction, based on a first evaluation result and a second evaluation result. The first evaluation result is a result of evaluating a first willingness of the user to continue the interaction by inputting content of the interaction to a large language model. The second evaluation result is a result of evaluating a second willingness of the user to continue the interaction based on an uttered word count of the user.

According to Aspect 6, the information processing apparatus of any one of Aspects 1 to 5, further includes a user information acquisition unit, a presentation information generation unit, and an information presenting unit. The user information acquisition unit acquires information on the user. The presentation information generation unit generates information on a topic related to the information on the user, based on the information on the user. The information presenting unit presents the information on the topic to the user in a case where the interaction starts.

According to Aspect 7, in the information processing apparatus of Aspect 6, the topic includes information on a facility related to the information on the user.

According to Aspect 8, the information processing apparatus of Aspect 6 or 7, further includes an updating unit. The updating unit updates the information on the user, based on content of the interaction after the interaction with the user ends.

According to Aspect 9, an interactive system includes a terminal apparatus to be used by a user, and an information processing apparatus to communicate with the terminal apparatus via a communication network. The information processing apparatus includes an input unit, an evaluation unit, and a response unit. The input unit receives, from the terminal apparatus, an input from the user. The evaluation unit evaluates a willingness of the user to continue an interaction, based on the input. The response unit outputs a response related to ending the interaction, based on a result of the evaluation by the evaluation unit. The terminal apparatus includes a transmission unit, a reception unit, and an output control unit. The transmission unit transmits the input from the user to the information processing apparatus. The reception unit receives the response from the information processing apparatus. The output control unit controls outputting of the response to the user.

According to Aspect 10, an interaction control method to be executed by a computer, includes: receiving an input from a user; evaluating a willingness of the user to continue an interaction, based on the input; and outputting a response related to ending the interaction, based on a result of the evaluating.

According to Aspect 11, a program causing a computer to execute: receiving an input from a user; evaluating a willingness of the user to continue an interaction, based on the input; and outputting a response related to ending the interaction, based on a result of the evaluating.

According to Aspect 12, an interactive system includes circuitry that receives an input from a user, evaluates a willingness of the user to continue an interaction, based on the input, and controls a response related to ending the interaction to the user, based on a result of the evaluation.

The above-described embodiments are illustrative and do not limit the present invention. Thus, numerous additional modifications and variations are possible in light of the above teachings. For example, elements and/or features of different illustrative embodiments may be combined with each other and/or substituted for each other within the scope of the present invention. Any one of the above-described operations may be performed in various other ways, for example, in an order different from the one described above.

1. An information processing apparatus comprising circuitry configured to:
receive an input from a user;
evaluate a willingness of the user to continue an interaction, based on the input; and
output a response related to ending the interaction, based on a result of the evaluation.

2. The information processing apparatus according to claim 1, wherein the response related to ending the interaction includes a response proposing ending the interaction to the user.

3. The information processing apparatus according to claim 1, wherein the circuitry is configured to output the response related to ending the interaction, based on the result of the evaluation and a threshold value that changes as the interaction progresses.

4. The information processing apparatus according to claim 3, wherein the threshold value changes based on one of a duration of the interaction and an utterance turn count in the interaction, or one of a duration of a same topic and an utterance turn count for the same topic.

5. The information processing apparatus according to claim 1, wherein
the circuitry is configured to evaluate the willingness of the user to continue the interaction, based on a first evaluation result and a second evaluation result,
the first evaluation result being a result of evaluating a first willingness of the user to continue the interaction by inputting content of the interaction to a large language model,
the second evaluation result being a result of evaluating a second willingness of the user to continue the interaction based on an uttered word count of the user.

6. The information processing apparatus according to claim 1, wherein the circuitry is configured to:
acquire information on the user;
generate information on a topic related to the information on the user, based on the information on the user; and
present the information on the topic to the user in a case where the interaction starts.

7. The information processing apparatus according to claim 6, wherein the topic includes information on a facility related to the information on the user.

8. The information processing apparatus according to claim 6, wherein the circuitry is configured to update the information on the user, based on content of the interaction after the interaction with the user ends.

9. An interactive system comprising:
the information processing apparatus according to claim 1; and
a terminal apparatus to communicate with the information processing apparatus via a communication network and to be used by the user,
the terminal apparatus including another circuitry configured to:
transmit the input from the user to the information processing apparatus;
receive the response from the information processing apparatus; and
control outputting of the response to the user.

10. An interaction control method comprising:
receiving an input from a user;
evaluating a willingness of the user to continue an interaction, based on the input; and
controlling a response related to ending the interaction to the user, based on a result of the evaluating.

11. A non-transitory recording medium storing a plurality of instructions which, when executed by one or more processors, causes the one or more processors to perform an interaction control method comprising:
receiving an input from a user;
evaluating a willingness of the user to continue an interaction, based on the input; and
controlling a response related to ending the interaction to the user, based on a result of the evaluating.
